(19) United States
(12) Patent Application Publication
(10) Pub. No.: US 2014/0232417 A1
(43) Pub. Date: Aug. 21, 2014

(54) ELECTRICAL MEASURING SYSTEM

(71) Applicants: FRIEDRICH-ALEXANDER-UNIVERSIATAET ERLANGEN- NRERNBERG, Erlangen (DE); HORST SIEDLE GMBH & CO. KG, Furtwangen (DE)

(72) Inventors: Ernst HALDER, Stuttgart (DE); Peter DINGLER, Aalen-Ebnat (DE); Sebastian Mann, Lauf A.d. Pegnitz (DE); Stefan Lindner, Erlangen (DE); Francesco Barbon, Erlangen (DE); Gabor Vinci, Bamberg (DE); Alexander Kölpin, Bamberg (DE)

(73) Assignees: Friedrich-Alexander-Universitaet Erlangen-Nuernber, Erlangen (DE); HORST SIEDLE GMBH & CO. KG, Furtwangen (DE)

(21) Appl. No.: 14/177,672

(22) Filed: Feb. 11, 2014

(30) Foreign Application Priority Data
Feb. 20, 2013 (DE) 10 2013 202 765.6

(51) Int. Cl. G01S 13/02

(52) U.S. Cl. CPC G01S 13/02
USPC 324/642

(57) ABSTRACT

A measuring system is described which includes a sensor for receiving an electromagnetic wave and a guide component for guiding the electromagnetic wave. The guide component is embodied as an elongated, preferably metal, profile component which contains, in a longitudinal direction, a slot for guiding the electromagnetic wave.

PRIORITY STATEMENT

The present application hereby claims priority under 35 U.S.C. §119 to German patent application number DE 102013202765.6 filed Feb. 20, 2013, the entire contents of which are hereby incorporated herein by reference.

### FIELD

At least one embodiment of the invention generally relates to a measuring system comprising a sensor for receiving an electromagnetic wave and a guide component for guiding the electromagnetic wave.

### BACKGROUND

A distance measuring system is disclosed in the publication “Promise of a Better Position” by Gabor Vinci, Stefan Lindner, Francesco Barbon, Robert Weigel and Alexander Koelpin, published in “IEEE Microwave Magazine, November/December 2012 Supplement. With this measuring system, an electromagnetic wave is transmitted from a sensor to a reflector, which may be moving, is reflected thereon, and is then received once more by the sensor. The distance between the reflector and the sensor can be determined based on the physical variables for the transmitted wave and the received wave. The electromagnetic wave is transmitted through ambient air.

A measuring system is known, for example, from the DE 10 2010 026 020 A1, for which the electromagnetic waves are coupled into a waveguide and are guided therein.

### SUMMARY

At least one embodiment of the present invention is directed to an improved measuring system comprising a sensor and a guide component.

The measuring system according to at least one embodiment of the invention comprises a sensor for receiving an electromagnetic wave as well as a guide component for guiding the electromagnetic wave. The guide component is embodied as elongated profile component provided with a slot in longitudinal direction for guiding the electromagnetic wave.

### BRIEF DESCRIPTION OF THE DRAWINGS

Additional features, options for use, and advantages of the invention follow from the description below of example embodiments of the invention which are shown in the Figures. All described or illustrated features by themselves or in any optional combination represent the subject matter of the invention, regardless of how they are summarized in the patent claims or the references back, as well as independent of their formulation and/or representation in the description and/or in the Figures.

FIG. 1 shows a schematic block diagram of an example embodiment of a measuring system according to the invention, comprising a guide component.

FIG. 2a shows a schematic cross section through a first example embodiment of the guide component for the measuring system according to the invention, as shown in FIG. 1.

FIGS. 2b, 2c show schematic perspective views of the guide component according to FIG. 2a, without and with a reflector.

FIG. 3a shows a schematic cross section through a second example embodiment of the guide component for the measuring system shown in FIG. 1.

FIG. 3b shows a schematic perspective view of the guide component according to FIG. 3a, comprising a reflector.

FIG. 3c shows an alternative to the second example embodiment shown in FIG. 3a.

FIG. 4 shows a schematic cross section through a third example embodiment of the guide component according to the invention for the measuring system shown in FIG. 1.

FIGS. 5a, 5b show schematic cross sections for additional embodiments of the guide component for the measuring system according to FIG. 1.

### DETAILED DESCRIPTION OF THE EXAMPLE EMBODIMENTS

The present invention will be further described in detail in conjunction with the accompanying drawings and embodiments. It should be understood that the particular embodiments described herein are only used to illustrate the present invention but not to limit the present invention.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention Like numbers refer to like elements throughout the description of the figures.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of embodiments of the present invention.

The measuring system according to at least one embodiment of the invention comprises a sensor for receiving an electromagnetic wave as well as a guide component for guiding the electromagnetic wave. The guide component is embodied as elongated profile component provided with a slot in longitudinal direction for guiding the electromagnetic wave.

The profile component with the slot can be produced easily by using a continuous casting method and, if applicable, making a saw cut. In the process, a high precision of the slot width in particular can be achieved without higher expenditure.

The slot according to one modification is formed by two opposite-arranged webs, wherein the two webs preferably are oriented approximately parallel to each other. The surface formed by these webs can advantageously have a bulge or can be slanted and/or the slot can usefully be covered by a foil.

According to one embodiment of the invention, the profile component can contain a waveguide extending in longitudinal direction to which the slot is assigned. The waveguide preferably has an essentially rectangular surface as seen in the cross section, wherein the slot is contained in one of the surfaces which spatially delimits the waveguide.

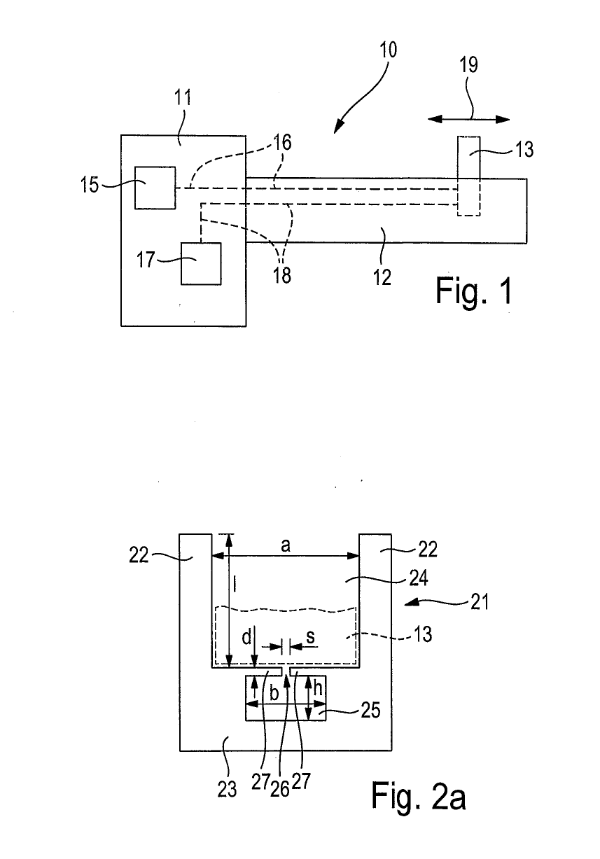

FIG. 1 shows a measuring system 10 which comprises a sensor 11, a guide component 12 and a reflector 13.

The sensor 11 can be any type of electrical circuit which is suitable for generating a first electromagnetic wave 16 based on predetermined operating variables, using a transmitter 15, for transmitting this wave in the direction of the reflector 13 and for receiving a second electromagnetic wave 18 coming back from the reflector 13, using a receiver 17, as well as for determining its characteristics. Using means that are not shown in further detail herein, for example by using a digital computer, the sensor 11 can furthermore determine at least one specifiable target variable from the known operating variables and from the characteristics determined for the two waves, wherein this target variable can be a phase difference between the transmitted wave 16 and the received wave 18. On the basis of this target variable, for example, the distance between the reflector 13 and the sensor 11 can then be determined.

The sensor 11, for example, can be arranged in a manner that is comparable or similar to the six-port technology, as described in the aforementioned publication. However, it should be noted that the sensor 11 need not be based absolutely on this six-port technology, but can also be embodied in a different way.

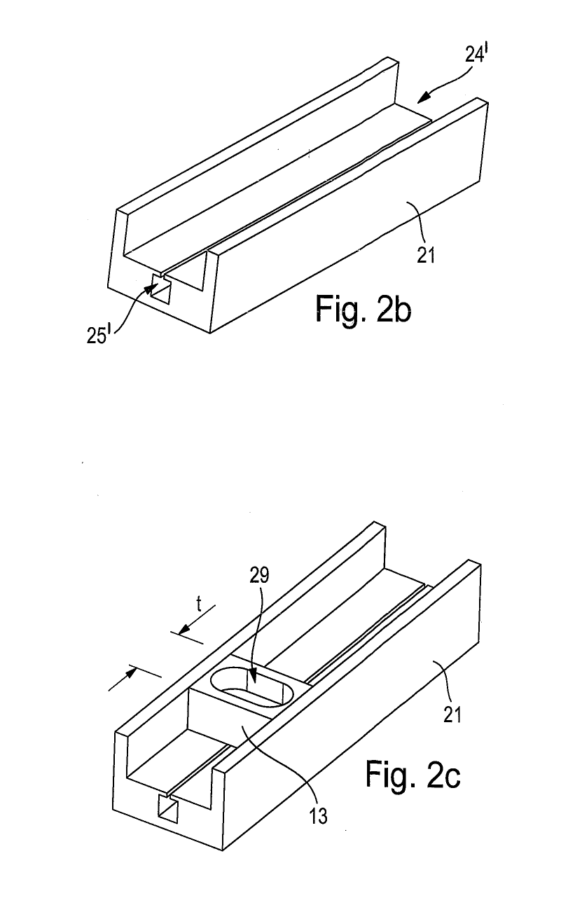

The guide component 12 functions to guide the transmitted first wave 16 as well as the reflected second wave 18. The guide component 12 can be composed of metal, glass, plastic, ceramics or any other type of material which is suitable for guiding an electromagnetic wave. The guide component 12 has a longitudinal direction in which the two waves 16, 18 propagate in opposite directions. The guide component 12 is explained in further detail in the following with the aid of FIGS. 2 to 4.

A coupling component can be provided between the sensor 11 and the guide component 12, if necessary, which is suitable for coupling the electromagnetic wave coming from the sensor 11 into and/or out of the guide component 12.

The reflector 13 is arranged and/or assigned to the guide component 12 in such a way that the transmitted first wave 16 impinges on the reflector 13 and is reflected thereon in the form of the second wave 18. The reflector 13 can be composed of metal, glass, plastic, ceramics or any other material suitable for reflecting an electromagnetic wave. As shown with the arrow 19, the reflector 13 can be displaced in longitudinal direction of the guide component 12.

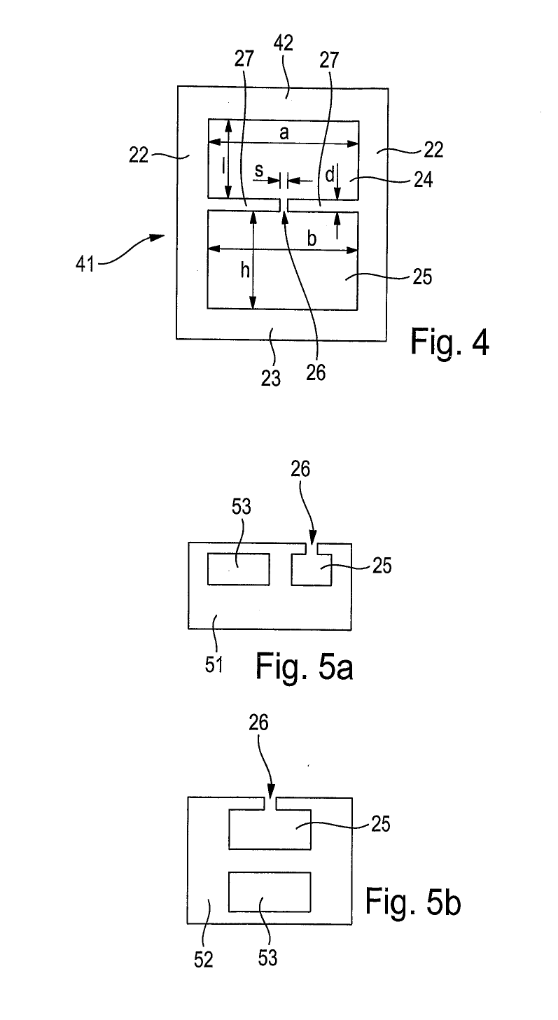

The reflector 13 is not essential, noting that the first wave 16 can also be reflected in a different manner. See, for example, the below explanation in connection with the example in FIG. 4.

At least the guide component 12 and, if applicable, also the reflector 13 can be positioned so as to be surrounded by air or any other medium, such as oil.

During the operation of the measuring system 10, the first wave 16 is transmitted by the transmitter 11 and is guided by the guide component 12 to the reflector 13. The second wave 18 which is reflected back from the reflector 13 is guided by the guide component 12 to the sensor and is received there. As previously explained, the distance between the reflector 13 and the sensor 11 can be determined based on the operating variables for the transmitted first wave 16 and the characteristics of the received second wave 18.

A first example embodiment of the guide component 12 is shown in FIGS. 2a, 2b, 2c and is embodied as an elongated metal profile component 21 with a specifiable length and uniform cross section. The elongated metal profile component 21 can be produced, for example, from aluminum with the aid of a continuous casting process and, if applicable, by making a saw cut. However, it should be noted that it is not absolutely necessary for the elongated metal profile component 21 to have a uniform cross section, but that deviations are possible.

The elongated metal profile component 21 has an approximately U-shaped cross section with two legs 22 and a connecting part 23. The two legs 22 are oriented approximately parallel to each other and the connecting part 23 is arranged approximately transverse thereto. The two legs 22 are arranged at a distance “a” to each other and respectively have a length “l”. The two legs 22 and the connecting part 23 enclose an approximately rectangular first surface 24 (as seen in the cross section) which forms a first waveguide 24′ (seen three-dimensionally) that extends in longitudinal direction of the elongated metal profile component 21. Approximately in the center between the two legs 22, the connecting part 23 contains a second surface 25 which (as seen in the cross section) is embodied approximately rectangular and (seen three-dimensionally) forms a second waveguide 25′ which extends in longitudinal direction of the elongated metal profile component 21. The second surface has a width b and a height h, wherein the rectangular-shaped first and the second surfaces 24, 25 are oriented approximately parallel to each other. A slot 26 with a slot width s is provided approximately in the center between the two legs 22 which connects (as seen in the cross section) the first surface 24 and the second surface 25. The slot 26 is formed by two oppositely-arranged webs 27 which are oriented approximately parallel to each other. The two webs 27 are embodied substantially identical and have a thickness d. The spacing between the two webs 27 corresponds to the slot width s of the slot 26.

The slot 26 of the elongated metal profile component 21 is intended for the guidance of the first and the second wave 16, 18. The waves 16, 18 in this case essentially travel “inside” the slot 26 and/or between the two webs 27 that form the slot 26. This follows from the fact that the waves 16, 18 essentially only slightly penetrate the surface of the elongated metal profile component 21, in particular at high frequencies, as a result of the skin effect. The waves 16, 18 can thus propagate in longitudinal direction of the elongated metal profile component 21 along the slot 26. The slot 26 of the elongated metal profile component 21 thus represents a waveguide for the waves 16, 18.

The dimensioning of the slot width s and, if applicable, also the dimensioning of the thickness d of the two webs 27 that form the slot 26 influences the propagation of the waves 16, 18 along the slot 26. Insofar, the slot width s in particular is dependent on the desired propagation characteristics of the waves 16, 18 in the elongated metal profile component 21.

The dimensioning of the distance a, the length l, the width b, the height h, the thickness d and the slot width s, among other things, also depends on the frequency of the waves 16 18 that are generated.

The aforementioned dimensioning of the elongated metal profile component 21 can thus be selected such that if possible only a first mode of the waves 16, 18 are generated in the slot 26 and that modes of a higher order for the waves 16, 18 are not generated if possible in the first and second waveguides 24′, 25′, formed by the first and second surfaces 24, 25.

For example, if the sensor 11 is a radar sensor and if the frequency of the generated electromagnetic wave is in the frequency range of approximately 24 GHz, the spacing a can be approximately 20 mm, the length l about 10 mm, the width b and the height h, for example, approximately 5 mm, the thickness d approximately 1 mm and the slot width s about 0.5 mm. The length of the elongated metal profile component 21 in longitudinal direction is for the most part optional and can be approximately 1 m.

The elongated metal profile component 21 need not be totally composed of metal. It can be sufficient if essentially only the two webs 27 that form the slot 26 and, if applicable, the surfaces delimiting the second waveguide 25′ (spatially), are made of metal or have metal surfaces.

According to FIG. 2c, the reflector 13 is embodied approximately cube-shaped. The width and height of the reflector 13 in this case corresponds essentially to the spacing “a” and the length “l” of the two legs 22 of the elongated metal profile component 21. The aforementioned dimensions for the reflector 13 and the elongated metal profile component 21 are adapted to each other in such a way that the reflector 13 can be displaced in longitudinal direction of the elongated metal profile component 21. With the aforementioned example dimensioning of the elongated metal profile component 21, the dimensions for the reflector 13 can be approximately 0.1 mm smaller than the corresponding dimensions of the elongated metal profile component 21, so that a gap remains between the elongated metal profile component 21 and the reflector 13.

The reflector 13 has a depth t as seen in longitudinal direction of the elongated metal profile component 21. This depth t influences the reflection of the first wave 16 and thus the generating of the second wave 18. The depth t therefore depends on the desired propagation characteristics of the second wave 18. The depth t furthermore depends on the slot width s of the elongated metal profile component 21.

The reflector 13 can be composed completely of metal, for example of aluminum. However, it is also possible to provide only one or more of the surfaces of the reflector 13 with a metal coating.

For the present example, the reflector 13 does not extend into the region of the slot 26 of the elongated metal profile component 21. The surface of the reflector 13 that faces the slot 26 is therefore essentially flat, which is shown in particular in FIG. 2a.

As previously explained, the first wave 16 propagates in and/or along the slot 26, starting from the sensor 11 in the direction toward the reflector 13. In the region of the reflector 13, the first wave 16 is influenced by the reflector 13 to the effect that it is partially reflected and in part propagates inside the slot 26. On the one hand, the reflected second wave 18 is generated, which propagates inside the slot 26 in counter direction to the sensor 11, as well as a third wave which moves past the reflector 13 inside the slot 26 in the direction toward the far end of the elongated metal profile component 21.

The division of the first wave 16 into the second wave 18 and the third wave depends, as previously mentioned, among other things on the depth t of the reflector 13 and, if applicable, on the slot width s of the elongated metal profile component 21. This division furthermore depends on the gap that exists along the slot 26, between the elongated metal profile component 21 and the reflector 13.

If necessary, the far end of the elongated metal profile component 21 can be provided with an end component, arranged opposite the sensor 11, which is suitable for absorbing or otherwise influencing the aforementioned third wave without reflection, for example by deflecting or redirecting it.

Alternatively, it is also possible that the reflector 13 extends partially or completely into the slot 26 of the elongated metal profile component 21. In that case, it is possible that the first wave 16 is basically reflected completely, so that no end component is required.

The example embodiment shown in FIG. 2c contains an oval recess 29 in the reflector 13 surface that is facing away from the slot 26. A pin or the like can engage in this recess 29 which can be used to displace the reflector 13 in longitudinal direction of the elongated metal profile component 21. Owing to the oval embodiment of the recess 29, the pin need not be displaced precisely in longitudinal direction, but can also have some play transverse to the longitudinal direction.

If the measuring system 10 is used to obtain a distance measurement, the reflector 13 can be connected via the aforementioned pin to a component to be measured. The distance which can be measured with the aid of the measuring system 10 in that case corresponds to the length of the elongated metal profile component 21.

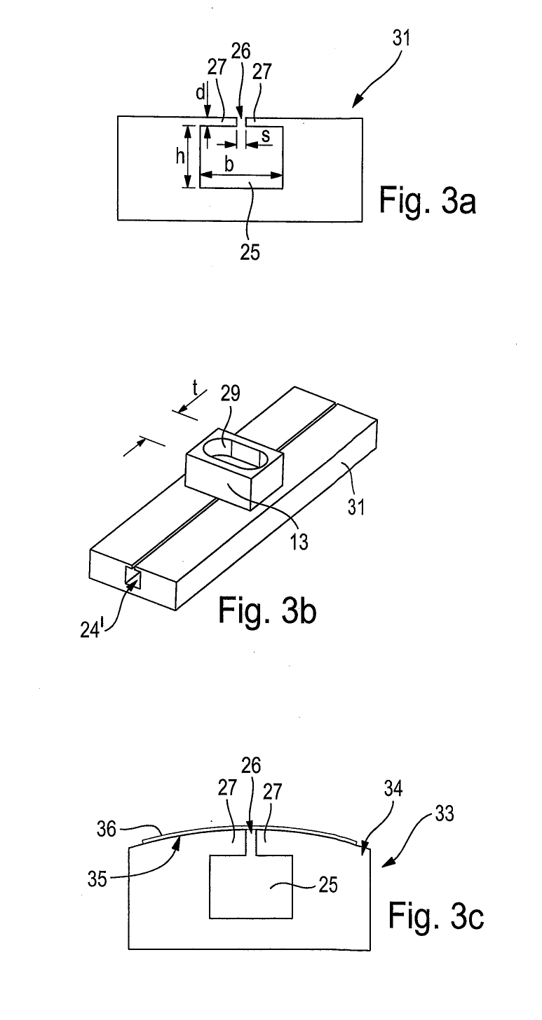

A second example embodiment of the guide component 12 is shown in FIGS. 3a, 3b, wherein this concerns a metal profile component 31 with a specifiable length and uniform cross section. The metal profile component 31 can be produced from aluminum with the aid of a continuous casting method and, if applicable, by making a saw cut.

The metal profile component 31 in FIGS. 3a, 3b for the most part corresponds to the elongated metal profile component 21 in FIGS. 2a, 2b, 2c. In contrast to the elongated metal profile component 21, the metal profile component 31 does not have legs 22 and is therefore not U-shaped (as seen in the cross section), but has a rectangular shape, wherein this rectangular shape of the metal profile component 31 essentially corresponds to the connecting part 23 of the elongated metal profile component 21.

Concerning the metal profile component 31 in FIGS. 3a, 3b, we therefore refer to the explanations provided for the elongated metal profile component 21 shown in FIGS. 2a, 2b, 2c. It should be noted that the same reference numbers are used in FIGS. 3a and 3b as are used in FIGS. 2a, 2b and 2c.

In contrast to the elongated metal profile component 21 shown in FIGS. 2a, 2b, 2c, with the metal profile component 31, no modes of a higher order are essentially generated for the waves 16, 18 outside of the metal profile component 31, shown in FIGS. 3a 3b, meaning in particular (in FIG. 3a) above the slot 26.

A guide component 33 is shown in FIG. 3c which comprises alternative and additional features as compared to the guide component 21 in FIG. 3a.

Thus, the surface 34 of the profile component 33, which is formed by the webs 27, is provided with a bulge 35. The bulge 35 extends crosswise to the longitudinal direction of the profile component 33. The bulge 35 is not shown true to scale in FIG. 3c and, in particular, can also be embodied flat.

With the aid of this bulge 35, it is possible to achieve that liquids such as drops of water do not remain on the surface 34 of the profile component 33 but for the most part run off.

Instead of the bulge 35, one or several slanted surfaces or the like can also be provided which allow the aforementioned liquids to flow off in a corresponding manner.

The slot 26 can furthermore be closed off with a suitable cover.

A foil 36 can thus be affixed to the surface 34 of the profile component 33, wherein this foil 36 extends in longitudinal direction of the profile component 33. The foil 36 is positioned transverse to the longitudinal direction, at least in the region of the slot 26, thereby covering the slot completely. However, it is not necessary for the foil 36 to cover the surface 34 completely. The foil 36, for example, can be glued onto the profile component 33.

The foil 36 in particular is embodied extremely thin. The representation in FIG. 3c is therefore not true to scale. The foil 36 is produced from a material with a dielectric constant which is selected to keep the influence of the foil 36 onto the measuring system 10 as low as possible. The foil 36 is furthermore embodied to be mostly dispersion-free.

The slot 26 can be closed off with the aid of the foil 36 and can thus be protected against penetrating dirt or liquids or the like. If applicable, the waveguide 25′ that is formed by the surface 25 can be sealed off completely against the outside with this foil 36.

In place of the foil 36, other means can also be used for preventing dirt from entering or even for sealing the waveguide 25′. For example, the complete metal profile component 31 can be surrounded by a shrinkable sleeve, or the waveguide 25′ can be filled with a filler material, wherein these means can be embodied to have an insignificant wettability of their surface/surfaces (so-called Lotus effect).

The bulge 35 and/or the foil 36 can be provided separately or jointly for all of the above-described example embodiments.

If the bulge 35 and/or the foil 36 are present, it may be necessary to correspondingly adapt the reflector 13 on its surface that is facing the bulge 35 and/or the foil 36.

A third example embodiment of the guide component 12 is shown in FIG. 4. It concerns a metal profile component 41 with a specifiable length and uniform cross section. The metal profile component 41 can be produced of aluminum, for example, using a continuous-casting method and if applicable by making a saw cut.

The metal profile component 41 in FIG. 4 corresponds for the most part to the elongated metal profile component 21 shown in FIGS. 2a, 2b, 2c. In contrast to the elongated metal profile component 21, the two legs 22 of the metal profile component 41 are connected via a bridge component 42.

With respect to the metal profile component 41 in FIG. 4, we therefore point to the explanations provided for the elongated metal profile component 21 in FIGS. 2a, 2b, 2c. It should be noted that the same reference numbers have been used in FIG. 4 as in FIGS. 2a, 2b, 2c.

The reflector 13 for the third embodiment shown in FIG. 4 can be contained in the first waveguide 24′ (as seen in the cross section: first surface 24) or in the second waveguide 25′ (as seen in the cross section: second surface 25). A rod or the like can be affixed to the reflector 13 which is also contained in the respective waveguide 24′, 25′, wherein the length of the rod can be such that it projects over the far end of the metal profile component 41, arranged opposite the sensor 11, and can be connected there to a component to be measured.

Alternatively, the third example embodiment of FIG. 4 can be used as filling-level measuring system. In that case, the metal profile component 41 is oriented approximately vertically, and the two waveguides 24′, 25′ of the metal profile component can contain a liquid for which the filling level is to be measured. The far end of the metal profile component 41 which is positioned opposite the sensor 11 is located below the surface of the liquid, while the sensor 11 is located above the surface. A reflector 13, of the type as explained so far, is not present in this embodiment. Instead, the surface of the liquid functions as a reflector. The first wave 16 is partially reflected on the surface of the liquid and partially passes through the liquid. The second wave 18 that is reflected on the surface of the liquid and the third wave which passes through the liquid are generated in this way from the first wave 16, as previously explained in connection with FIG. 2c.

It should be noted that the above-explained filling-level measuring can correspondingly also be used with the other described example embodiments.

FIGS. 5a and 5b contain additional embodiments of the guide component 12 shown in FIG. 1. These Figures relate to profile components 51, 52 which are similar to the profile component 31 in FIGS. 3a, 3b, 3c. In particular, the profile components 51, 52 respectively contain a corresponding waveguide 25′ formed by the surface 25, as well as the slot 26, as is the case for the profile component 31. Insofar, we point to the explanations provided for FIGS. 3a, 3b, 3c.

Additionally provided is a reference waveguide 53′ for the profile components 51, 52 that is formed by a surface 53 and, for the example shown in FIG. 5a, is arranged offset to the waveguide 25′ and, for the example in FIG. 5b, is arranged below the waveguide 25′. It is understood that the reference waveguide 53′ can also be arranged differently in view of the waveguide 25′.

The reference waveguide 53′ can have a rectangular cross-sectional surface for which the dimensions are larger or smaller than those of the waveguide 25′. The reference waveguide 53′ does not contain a slot.

Means for reflecting the reference wave can be provided at the far end of the profile components 51, 52, which is arranged opposite the sensor 11.

A reference wave which, in particular, corresponds to the first wave 16 can be coupled into and guided inside the reference waveguide 53′, formed by the surface 53. The reference wave is not influenced by the reflector 13. The reference wave is reflected at the far end of the profile components 51, 52 and is then guided back to the sensor 11 and received thereon.

Alternatively, it is also possible that the end section already mentioned in connection with FIGS. 2a, 2b, 2c is embodied such that the previously mentioned third wave is redirected from the waveguide 25′ into the waveguide 53′. The redirected third wave is then guided back inside the reference waveguide 53′ to the sensor 11 where it is received.

With the aid of the reference wave, a reference measurement can be carried out which can be used to compensate, for example, for temperature-dependent changes in length and/or other changes of the profile components 51, 52.

It is understood that the above-explained reference waveguide 53′ and the reference measurement which can be carried out with this waveguide can be used for all previously described example embodiments.

An additional sensor, arranged at the far end of the profile components 21, 31, 41, represents a further option for carrying out a reference measurement for the examples shown in FIGS. 2 to 4. On the one hand, this sensor can be provided for receiving the third wave, wherein this third wave functions as reference wave.

On the other hand, the additional sensor can also be provided for transmitting waves, thereby resulting in two measuring systems which operate in opposite directions, starting from different ends of the profile components 21, 31, 41. In that case, two opposite-arranged waves are obtained. Preferably, the two measuring systems can be operated alternately, so that difference calculations in view of the distance and/or the position of the reflector 13 can be realized within the profile components 21, 31, 41.

No reference waveguide is thus required for cases containing two sensors, as is required for the embodiments in FIGS. 5a, 5b.

It should be noted that with the example embodiments described, the first wave 16 does not absolutely have to be generated by the sensor 11. Instead, it is possible to generate the first wave 16 independent of the sensor 11 and to couple it in some manner into the slot of the profile components 21, 31, 41. The same is true for the aforementioned additional sensor.

We furthermore want to point out that with the aforementioned example embodiments, not only the waves 16, 18 may be present but also a plurality of other waves with different frequencies which are guided in a corresponding manner inside the slot 26. This may be necessary in particular in view of a clear determination of the spacing between the sensor 11 and the reflector 13.

1. A measuring system, comprising:
a sensor, configured to receive an electromagnetic wave; and
a guide component, configured to guide the electromagnetic wave, the guide component being embodied as an elongated profile component, provided in a longitudinal direction with a slot configured to guide the electromagnetic wave.

2. The measuring system of claim 1, wherein the slot is formed by two opposite-arranged webs.

3. The measuring system of claim 2, wherein the two webs are oriented approximately parallel to each other.

4. The measuring system of claim 2, wherein a distance between the two webs specifies a slot width for the slot.

5. The measuring system of claim 2, wherein a surface formed by the two webs contains a bulge or is a slanted surface.

6. The measuring system of claim 1, wherein the slot is covered.

7. The measuring system of claim 1, wherein the elongated profile component comprises a waveguide that extends in longitudinal direction, to which the slot is assigned.

8. The measuring system of claim 7, wherein the waveguide has an essentially rectangular shape, as seen in the cross section, and wherein the slot is contained in one of the surfaces that spatially delimit the waveguide.

9. The measuring system of claim 7, wherein the slot is approximately in a center of the waveguide.

10. The measuring system of claim 7, wherein the profile component has an approximately rectangular cross-sectional shape.

11. The measuring system of claim 7, wherein the profile component comprises an additional waveguide extending in longitudinal direction, to which the slot is assigned.

12. The measuring system of claim 11, wherein the waveguide and additional waveguide are connected to each other via the slot.

13. The measuring system of claim 11, wherein the profile component has an approximately U-shaped cross section with two legs.

14. The measuring system of claim 13, wherein the profile component comprises a bridge component which connects the two legs.

15. The measuring system of claim 1, further comprising:
a reflector, assigned to the slot of the profile component and configured to be displaceable in a longitudinal direction of the profile component.

16. The measuring system of claim 1, wherein the profile component and the reflector are composed of a metal.

17. The measuring system of claim 1, wherein the sensor is further configured to generate an electromagnetic wave and wherein the electromagnetic wave received by the sensor is generated as a result of reflection of the electromagnetic wave.

18. The measuring system of claim 1, further comprising an additional sensor, configured to receive an electromagnetic wave and wherein the sensor and the additional sensor are respectively assigned to respective ends of the profile component.

19. The measuring system of claim 6, wherein the slot is covered with a foil.

20. The measuring system of claim 3, wherein a distance between the two webs specifies a slot width for the slot.
